(19) United States
(12) Patent Application Publication
(10) Pub. No.: US 2011/0171107 A1
(43) Pub. Date: Jul. 14, 2011

(54) SYSTEM FOR HALTING THE INCREASE IN ATMOSPHERIC CARBON DIOXIDE AND METHOD OF OPERATION THEREOF

(75) Inventor: Roy Britten, Costa Mesa, CA (US)

(73) Assignee: California Institute of Technology, Pasadena, CA (US)

(21) Appl. No.: 12/986,742

(22) Filed: Jan. 7, 2011

Related U.S. Application Data
(60) Provisional application No. 61/293,151, filed on Jan. 7, 2010.

(51) Int. Cl. C01B 31/20; B01J 8/00

(52) U.S. Cl. 423/437.1; 422/162

(57) ABSTRACT

A system and method for collecting carbon dioxide present in the terrestrial atmosphere and sequestering the carbon dioxide. A renewable energy source, such as a wind turbine, provides electrical power without generating carbon dioxide emissions. The electricity is used to electrolyze seawater, providing a cathodic solution enriched in NaOH. By aeration of the cathodic solution, carbon dioxide is captured as Na₂CO₃. The cathodic solution is combined with precipitated carbonates are produced as solids and dumped in the ocean thereby sequestering carbon dioxide. The electrolysis produces H₂ and Cl₂ as product gases, which are captured and utilized.

### CROSS-REFERENCE TO RELATED APPLICATIONS

This application claims priority to and the benefit of co-pending U.S. provisional patent application Ser. No. 61/293,151 filed Jan. 7, 2010, which application is incorporated herein by reference in its entirety.

### FIELD OF THE INVENTION

The invention relates to pollution remediation in general and particularly to a system and a method that employ renewable energy to collect and sequester carbon dioxide from the atmosphere.

### BACKGROUND OF THE INVENTION

At present the atmospheric carbon dioxide (CO₂) is rising by about 4 gigatons per year. Acting as a greenhouse gas (e.g., a gas well-known to absorb and thereby capture infrared energy while being transparent to visible light energy), among other gases, CO₂ is believed to be causing a worldwide temperature rise. While serious attempts are being made to limit the CO₂ production it is unlikely that these efforts will prevent a serious temperature rise in future years.

There is appreciable prior art in the fields of capturing energy from renewable sources such as wind. 10 MW marine wind turbines are now being manufactured and use in various settings. For example, existing offshore wind turbine installations include Thanet Offshore Wind Farm in the UK (nameplate capacity 300 MW), Horns Rev 2 (nameplate capacity 209 MW), Rødsand I (nameplate capacity 166 MW) and Rodsand II (nameplate capacity 207 MW), in Denmark, and others. The Cape Wind project off Cape Cod, Mass. is proposed with a nameplate capacity of 468 MW. Other possible sources of renewable energy involve capturing solar energy.

While these uses of renewable energy displace the burning of fossil fuels and eliminate some addition of CO₂, they do nothing to diminish the amount of CO₂ already present in the atmosphere. Recent data published in the New York Times on Dec. 21, 2010 indicates that the concentration of CO₂ in the terrestrial atmosphere has reached approximately 390 parts per million (ppm), as measure by techniques developed by Dr. Charles David Keeling, and reported over the past half century in a curve known as the Keeling Curve.

There is a need for systems and methods that can decrease the concentration of CO₂ in the terrestrial atmosphere.

### SUMMARY OF THE INVENTION

According to one aspect, the invention features a system for sequestering carbon dioxide extracted from the terrestrial atmosphere. The system comprises a renewable energy source having an output terminal, the renewable energy source configured to provide electrical power without generating carbon dioxide emissions; an electrolytic cell configured to receive electrical energy from the output terminal of the renewable energy source, the electrolytic cell configured to electrolyze water to provide an alkaline cathodic solution; an aeration system configured to provide an interaction of the alkaline cathodic solution with carbon dioxide present in a terrestrial atmosphere to produce a cathodic solution enriched in carbon dioxide; a mixing system configured to mix water containing ions selected from the group consisting of calcium ions and magnesium ions with the cathodic solution enriched in carbon dioxide to produce a precipitate comprising the ions and the carbon dioxide; and an apparatus configured to form the precipitate into a solid to be sequestered.

In one embodiment, the renewable energy source is a wind turbine.

In another embodiment, the electrolytic cell configured to electrolyze water is an electrolytic cell configured to electrolyze seawater.

In yet another embodiment, the alkaline cathodic solution is a solution comprising NaOH.

In still another embodiment, the cathodic solution enriched in carbon dioxide comprises Na₂CO₃.

In a further embodiment, the system is configured to be seagoing.

In yet a further embodiment, the solid to be sequestered is configured to be sequestered by being deposited in an ocean.

According to another aspect, the invention relates to a method of sequestration of carbon dioxide extracted from the terrestrial atmosphere. The method comprises the steps of electrolyzing an aqueous solution using a renewable source of electrical power that operates without generating carbon dioxide to provide an alkaline cathodic solution; reacting the alkaline cathodic solution with carbon dioxide present in a terrestrial atmosphere to produce a cathodic solution enriched in carbon dioxide; mixing water containing ions selected from the group consisting of calcium ions and magnesium ions with the cathodic solution enriched in carbon dioxide to produce a precipitate comprising the ions and the carbon dioxide; separating the precipitate as a solid from the mixture of water and the cathodic solution; and sequestering the solid.

In one embodiment, the aqueous solution that is electrolyzed is seawater.

In another embodiment, the alkaline cathodic solution comprises NaOH.

In yet another embodiment, the renewable source of electrical power that operates without generating carbon dioxide is a wind turbine.

In still another embodiment, the cathodic solution enriched in carbon dioxide comprises Na₂CO₃.

In a further embodiment, the step of separating the precipitate as a solid comprises subjecting the precipitate to centrifugation.

In yet a further embodiment, the step of sequestering the solid comprises depositing the solid in an ocean.

In an additional embodiment, the electrolysis step provides H₂ as a product.

In one more embodiment, the electrolysis step provides Cl₂ as a product.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a schematic diagram showing an embodiment of the invention, in which elements are disclosed as follows: 100 is a sea-going barge or vessel, 102 is a wind turbine, 103 is a power connection from turbine 102 to barge 100, 104 is power conversion equipment to provide low voltage direct current, 106 is an electrolysis chamber capable of producing H₂ and Cl₂, 108 are storage regions or tanks of H₂ and Cl₂, 110 is a spray tower for a cathodic solution, 112 is a receptor tank or catch basin for solution that captures atmospheric CO₂, 114 is a pump used to add seawater to the solution containing captured CO₂, 116 is a centrifuge to make bricks of Ca carbonate and Mg carbonate precipitate, 118 are pushers to displace the bricks, and 120 is a chute for the bricks to descend to the sea with seawater residue.

FIG. 2 is a perspective view of an embodiment of the invention illustrated in FIG. 1.

FIG. 3 is a diagram illustrating the construction of a collector assembly for collecting insoluble carbonates according to principles of the invention.

### DETAILED DESCRIPTION

The amount of carbon dioxide in the atmosphere is widely believed to be correlated terrestrial atmosphere with average terrestrial temperatures. A graph showing the appreciable correlation between the concentration of CO₂ in the average air temperature in Antarctica over a period of the past approximately 400,000 years was published in The New York Times on Dec. 21, 2010. It is believed that increased CO₂ concentration in the terrestrial atmosphere above the highest levels of approximately 320 ppm measured over the past 400,000 years is likely to lead to catastrophic global warming. The present invention is directed to systems and methods that can reduce the concentration of CO₂ in the terrestrial atmosphere.

The present description provides systems that are expected to be powered by renewable energy sources, such as using wind turbines in marine regions where there are steady trade winds to generate electrical power. The generated power is expected to be used to electrolyze seawater to produce hydrogen and to generate an alkaline cathodic solution. The alkaline cathodic solution is expected to be used to take up CO₂ from the air. The CO₂— laden solution is expected to be treated to form a precipitate of calcium and magnesium carbonates from seawater. The precipitate is expected to be formed into cakes. The cakes are expected to be allowed to sink to the sea bottom where they are expected to permanently sequester the carbonates as rock. When scaled to sufficient size, these systems and methods are expected to be capable of removing 3 gigatons (metric) of carbon as CO₂ per year from the atmosphere for permanent sequestration. The hydrogen produced is expected to further reduce the CO₂ added to the atmosphere by replacing CO₂ producing fuel use.

The electrolysis of sea water has been done for many years with the production of hydrogen and a halogen (principally chlorine, Cl₂). In the present system and method, the hydrogen is expected to be compressed and bottled and shipped ashore for use or for sale. The chlorine also is expected to be compressed and bottled and shipped ashore. There it could be purified to separate out the bromine and fluorine that is expected to be present. Halogen feedstocks are also of commercial value and could be used in chemical processes or sold.

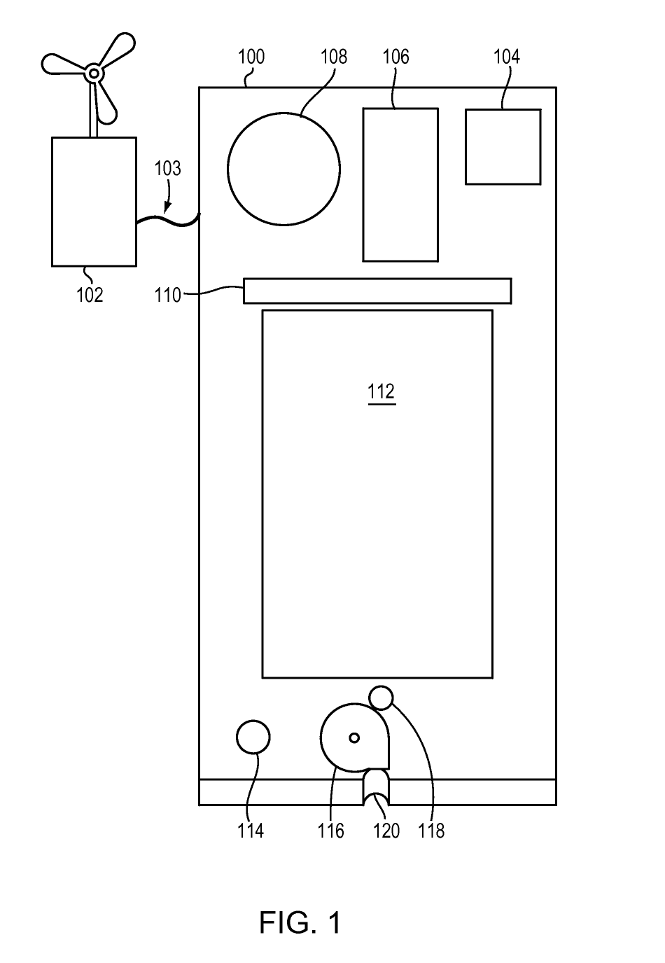

Turning to FIG. 1, a preferred embodiment includes a 100 meter to 300 meter long barge 100 for electrolysis and CO₂ collection with a large open area to collect drops of the alkaline solution. As illustrated in FIG. 1, one or more wind turbines 102 are provided, possibly on adjacent supporting or floating structures, and tethered to the barge 100 by way of a cable 103 that can carry the generated electrical power to the barge 100. At the upwind end of the barge 100, a set of nozzles 110 that stand some meters tall and some meters wide are provided to release droplets of the alkaline solution which at the trade wind speed are expected to fall into the catch basin within 100 meters, being converted from NaOH solution to Na₂CO₃ solution by reaction with CO₂ present in the atmosphere, according to a reaction such as:

2NaOH+CO₂→Na₂CO₃+H₂O Eqn. (1)

It is expected that the alkaline solution at the cathode will be sprayed into a container through which the trade wind flows for effective CO₂ uptake. The rate of CO₂ uptake into the alkaline solution is slow (30 to 100 micromoles per meter squared per second) so the solution is broken up into droplets by spraying to increase the area of contact. While the future construction is expected to probably be for a continuous process, the present description is discontinuous and for a single wind turbine for clarity.

About 35 kg carbon (C) could be processed per minute from the 160,000 m³ per minute of air passing through at trade wind speed. The solution is expected to be recycled by pumps to complete the uptake of CO₂. The use of a set of nozzles to form droplets of a given size range is well known in the fluid handling arts. However the collection of CO₂ from the atmosphere on this scale is novel. Since the CO₂ is present at 1 kg C per 4854 cubic meters of air, large quantities of air will have to be exposed to the alkaline sea water. Small droplet size increases the rate because of large surface area but decreases the falling rate. Experience would determine the ideal drop size. A screen at the downwind end is expected to collect stray small drops. The acceleration of a droplet (discounting air resistance) will be given by g=9.81 m/s². The distance travelled by a body falling from rest in a gravitational field is given by

D=½gt² Eqn. (2)

where D is the distance, g is the acceleration, and t is time in seconds.

Therefore, to have the droplet fall within a distance of 100 meters from a release point, for a 100 meter catch basin, the trade wind velocity V (which can be measured periodically) in meters/second is expected to define how high above the surface of the catch basin the release point of droplets could be, as follows. The time for the droplet to traverse the 100 meter catch basin is expected to be given by 100/V seconds. Therefore, to fall within the 100 meter distance, the height H from which the droplet can be released is less than or equal to

H=½g(100/V)² Eqn. (3)

The set of nozzles 110 therefore can be provided as a series of horizontal tubes in a vertical alignment, with control of the flow of solution to be exposed to the atmosphere limited to those tubes that are at or are below the height H determined according to Eqn. (3) for the prevailing speed of the trade wind at the then current time. Such flow control is expected to be provided by a series of valves controlled by a general purpose computer operating under a series of non-volatile instructions provided on a machine-readable medium.

A large centrifuge spinning on a vertical axis is expected to occupy the downwind end of the barge. The Na₂CO₃ solution is expected to be mixed with an amount of seawater calculated to provide maximum precipitation of Ca carbonate and Mg carbonate. A liftable plate is expected to be present in the centrifuge. The liftable plate is expected to be picked up along with precipitated cake. A pusher mechanism is expected to displace the cake so that it slides into the sea for permanent sequestration as rock on the sea bottom.

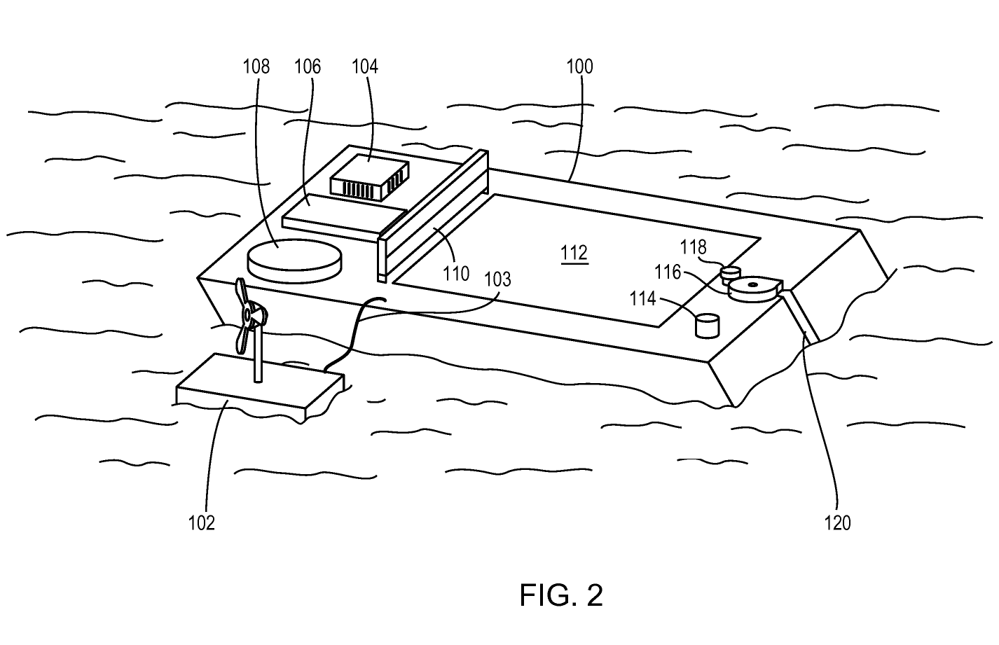

Turning to FIG. 2, the barge 100 is expected to contain electrolysis and associated equipment as well as temporary storage for H₂. Because H₂ has low density even liquefied (e.g., 7 L per Kg) the space must be large. A 300 m maximum length is planned as that is the maximum length for passage through the Panama Canal. However, in principle, the length could be any convenient length is passage through canals or rivers is not a concern.

Floating cables 103 from turbines 102 are expected to be supported on springy supports and connected with padding so that wave motion does not wear and damage the cables and their connectors.

Power conversion equipment 104 is expected to include a transformer and rectifier to produce a few volts DC as required for electrolysis.

Water electrolysis to produce H₂ is commercial and thus electrolysis equipment 106 does not need a detailed drawing or description. Sea water is pumped into the chamber continuously or as needed.

Storage tanks 106 are expected to be provided because the volume of H₂ produced is large. One turbine at 5 MW produces by electrolysis 100 kg/hr of H₂. A kilogram of liquefied H₂ occupies 7 liters. Thus a 5 MW turbine produces 700 liters of H₂ liquid per hour. 4 turbines make 400 kg/hr. 2800 L=2.8 m³ per hr or 7×24×2.8=470 m³ per week for four turbines.

The ship constructor Moss Maritime has built self-supporting spherical tanks for transporting fluids such as LNG. For a self-supporting spherical tank, of sufficient size to hold 470 meter³, we can write 4/3 πR³=470 meter3. Then, R=[(470)3/4×3.14159]^{1/3}=4.823 meters, suggesting that a tank almost 10 meters in diameter would be needed to hold the hydrogen generated in one week by four turbines

Other tank types that can be used (but are not shown in FIG. 2) are so-called membrane type tanks which are configured to match the contours of a ship to which they are fitted. Examples of membrane type tanks suitable for use in the invention are described in one or more of U.S. Pat. Nos. 3,990,382, 4,065,019, 4,099,649, 4,225,054, and 5,269,247.

Storage is required so that a tanker ship can pick up H₂ on occasion and deliver it to land-based users. Liquid H₂ is expected to be pumped through flexible insulated pipe. A model for the ship is a LNG carrier which carries 135,000 m³ in insulated spherical tanks at −260 deg F. and atmospheric pressure. Such a ship would carry the H₂ from 13,500 turbine x weeks of production, but of course at a lower temperature.

The alkaline cathode fluid that remains after H₂ release is expected to be pumped up to a spray tower 110 having one or more elevated horizontal pipes with many holes defined therein at such a flow rate that droplets would be formed which would fall in the trade wind in a distance of about 100 m and the alkali would be neutralized by absorbing atmospheric CO2 to form carbonates, principally sodium.

The receptor tank 112 is expected to extend for one hundred meters or more and would have partial internal barriers to prevent sloshing from wave motion and barge pitching.

The sodium carbonate when mixed with seawater precipitates calcium and magnesium carbonates, so new seawater is expected to be pumped in using a pump 112 and is expected to be mixed with the carbonate to maximize the calcium and magnesium carbonate precipitation.

A wind driven centrifuge 116 is expected to collect the precipitates into bricks in containers at the periphery. From time to time, the centrifuge is stopped and pushers 118 empty the containers into the chute 120 at the rear of the barge and the bricks slide into the sea. The centrifuge supernatant also flows down the chute, mixing with the anode solution which is piped to this point.

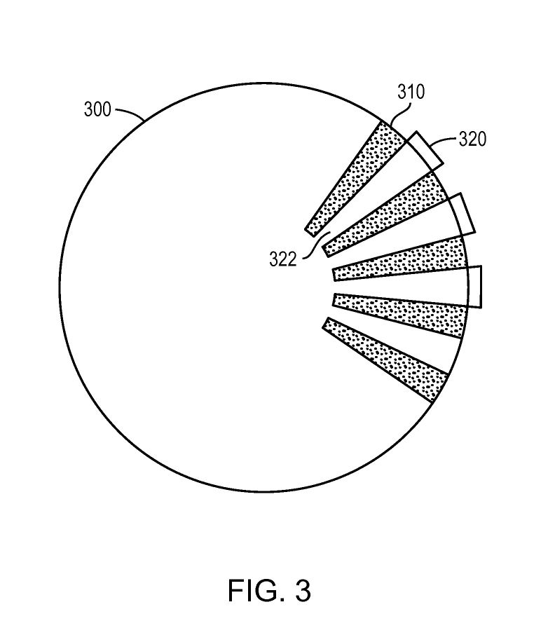

The centrifuge 116 is expected to have three main rotating parts: A base tank 116-1 which contains the fluid and has an exterior cylindrical wall of height H and a floor of radius R connected to the central shaft; a liftable cap 116-2 which seals to the top of the wall of the base tank 116-1 to prevent leakage; and a collector assembly 116-3 which fits inside of the base tank 116-1. As shown in FIG. 3 the collector assembly 300 has a floor and has a plurality (for example 25) triangular separators 310 of thin vertical metal. Each space 322 between the separators has at the periphery a flap 320 hinged at the base.

When assembled to spin the collector flaps are held vertically against the wall of the base tank 116-1 and the precipitate piles up on the flap. When the run is finished the cap is lifted up and the collector 116-3 is lifted up above the wall of the base tank 116-1. Then the assembly is rotated stepwise to bring each flap 320 over the chute 120 and a pusher arm 118 reaches in to the top of the pile of precipitate and drops down and scrapes the pile off the collector and lets it fall down the chute 120.

The anodic solution after release of chlorine is expected to remain acidic due to the presence of sulfate at about 14% of the chloride. The alkaline cathodic solution is expected to remain alkaline depending on the effectiveness of CO₂ absorption from air and precipitation of carbonates. These are expected to be controllable and is expected to be adjusted to match the anodic solution so that the mixture of the two major returning solutions is expected to match the ocean Ph and cause minimum disturbance.

The turbines are expected to be out of sight and be located in regions with few birds. Ecological damage is expected to be restricted to limited areas of the sea bottom. The hydrogen production is expected to supply a profitable income commensurate with the capital investment.

The floating turbines are expected to be anchored either to the sea bed or to a barge Anchoring from sea mounts is deeper than customary anchorage but is expected to present no difficulties for something on this large a scale. It is expected to add cost.

It is expected that the wind turbines will be placed in marine regions where there are steady trade winds. In a large installation, one can envision many thousand square kilometers that are occupied by hundreds of thousands of floating wind turbines in regions where there are seamounts for anchoring. Ecological damage is expected to be restricted to limited areas of the sea bottom.

In one example, a project according to the principles of the invention on a 17 Terawatt scale is expected to supply most of the earth's energy requirement, e.g., total energy, and not just electrical energy. The capital investment would have to be large and the time for construction would be long, but there are expected to be earnings from hydrogen and chlorine production. The investment could be borne internationally to avoid catastrophic global warming. A second example described is on a scale just sufficient to halt the growth of atmospheric carbon dioxide when the system goes into operation. The present net increase in atmospheric CO₂ of about 4 gigatons C per year could be stopped by precipitating about 3 gigatons of C per year to the sea bottom. That requires a little more than 3 TW of power production. The hydrogen production is expected to replace enough fossil fuel use and together with the precipitation of carbon, stop the growth of atmospheric CO₂. Beyond about 3 TW power level the CO₂ in the atmosphere could be reduced, permitting control of the atmospheric CO₂ to an appropriate level over a period of time. The concept is to establish an energy generating system in the trade wind regions of the oceans where the wind is a trustworthy renewable energy source. Several countries have developed offshore wind power plants. Their present plans include development of facilities so distant from shore that it is expected to be practical to convert the energy to hydrogen for shipment as liquid hydrogen (see Altmann M and Richert F (2001), Hydrogen Production at Offshore Wind Farms, Offshore Wind Energy Special Topic Conference, Brussels, Belgium, December 10-12.). The advantage to the distant trade wind marine location is that the noise and visual disturbance are far from population centers. In open ocean hundreds of miles from land there are few birds. Many parts of the planned system are known to operate on small scales including marine wind turbines, seawater electrolysis producing hydrogen and carbonate precipitation. Among the advantages are that there is no significant upper limit to the amount of energy available and there are steady high winds in many parts of the oceans. Regions can be chosen which have low frequency of storms and violent winds, such as the South Atlantic or Eastern South Pacific that lack tropical depressions.

### The Requirement for Power

The current world total energy usage is taken as a rate of 15 TW (15×10¹² watts) or about 440 Quads (quadrillion Btu) per year. This number is taken to represent all sources of energy from fossil fuels. This figure is likely to be low and probably will have grown to perhaps 20 TW by the time this plan could actually be started. This amount of power could be totally replaced by hydrogen from trade wind turbines. Present day turbines generate as much as 10 MW each. With down time and other losses due to hydrogen compression we can assume 8 MW each. (1.5×10¹³/8×10⁶=2.5×10⁶ turbines required). If windmills can be spaced at 10 per km² an area of 2.5×10⁵ km² is expected to be needed which is miniscule compared to the area of 4×10⁸ km² of the oceans. Presumably such a project is expected to be built in sections as capital becomes available.

### The Planned Fleets of Turbines

The design is for a large fleet of floating wind turbines. The Sway Company is building 10 MW turbines for deep water installation off Norway. They include a cylinder extending into the water with ballast at the lower end. The turbines are expected to be constructed according to the most efficient designs available at the time of construction. The turbines are expected to be mass-produced on an unprecedented scale. The turbines are expected to be spaced about 300 m on average and each linked to the anchoring system. Where the wind direction is relatively constant the cross-wind and down-wind spacings are expected to differ. The leading or windward edge of the cluster of turbines is expected to probably best be made up of units drawing power from ocean waves. Though not efficient these might make a contribution to the electrical power and they are expected to damp the waves making the wind turbines easier to handle. A large floating leading protective wall might be useful and economic as part of so large a collection of floating structures. Growth of organisms and fouling of bottoms is expected to be acceptable at any level and is expected to be no problem for stationary turbines.

### Electrolytic Production of Hydrogen

Electrolysis of seawater produces hydrogen at the cathode that may be made of iron since it is protected from oxidation. For reasonable electrode spacing about 2.3 volts is maintained between the electrodes and energy storage in hydrogen is fairly efficient. Pumps are expected to be required to increase the pressure or liquefy the hydrogen. There is expected to be plenty of power for this process but liquefaction comes at a cost of about a third of the power stored in hydrogen. Hydrogen storage system research continues and may come up with a less expensive system and the DOE is doing such research.

### Hydrogen Shipment

Because of the large scale of thousands of square kilometers of turbines in trade wind regions the ships carrying hydrogen are expected to be large enough so that the losses due to heat transfer is expected to be reduced by the large volume to surface area. Surface area rises as the square of the dimensions while volume rises as the cube. The ships are expected to use the hydrogen that boils off as their source of power, presumably reserving enough hydrogen for the return to the power generation locations. If the hydrogen is burned in air the energy output for the hydrogen from electrolysis of 15 terawatts for a year is 220 quads, but if fuel cells are used it will be higher.

### Capture of Atmospheric CO₂

The seawater at the cathode becomes alkaline. Air passed through or over this solution will be stripped of CO₂ and carbonates formed. In one study CO₂ from a flue was added to sea water and the pH was adjusted electrolytically so that the magnesium and calcium were completely precipitated as carbonates (see Barsky L, Rubenstein J, Barsky Sv, Kirzhner F, and Bodul O (1998), A multipurpose system of water purification and sea water softening. Reviews on Environmental Health V13(4), 205-212). While this has apparently not been done on the scale considered here it is expected that under the right conditions of concentration, current density and CO₂, calcium and magnesium carbonates can be produced and precipitated efficiently, using atmospheric air and sea water as sources of CO₂.

### Calculations

A 5 Mw turbine supplies a current of 2.17×10⁶ ampere at 2.3 v or 1320 moles/min and thus in a 1 min run generates enough alkali to collect 14 kg C in carbonates.

This solution is expected to be sprayed into a region in which many cubic meters of air from trade winds pass through. With 500 micron droplets and 100 liters of alkaline spray 11000 moles of CO₂ are expected to be taken up per min. At this rate the alkali is expected to quickly be saturated with CO₂. If the drops are coarse they will fall within a few meters downwind and no container will be required, only a large catch basin for the drops so that the alkaline solution can be recycled through the spray up to an efficient stopping point.

The present amount of CO₂ in air is 0.0582% by weight. That converts to 4584 m³ per Kg of C. In one embodiment a 20 m long row of sprayers 20 m high is provided. An area of 400 m² is expected to have wind blowing through at average trade wind speed of 6.66 m/second or 400 m/min (24 Km/hr). Thus in 1 min a volume of 160,000 m³ of air is expected to enter the spray region carrying 35 kg of C as CO₂. Drops of 1 to 2 mm size are expected to fall at 3 to 6 cm/sec and the catch basin is expected to need to be 100 m or so long to catch the laggard small drops perhaps with a screen at the downwind end. A small wastage of the alkaline solution falling into the sea is expected to do no harm and contribute to increasing ocean pH and precipitation.

The resulting sodium carbonate solution is expected to be mixed with seawater and the precipitate collected by centrifugation into cakes which is expected to effectively sink to the sea bottom. The cathode is expected to be scraped of carbonates and these added to the mixture.

### Quantitative Sequestration of Carbon

Sea water is about 3.5% salinity, principally sodium chloride with significant amounts of calcium and magnesium, with values that are typically, in parts per million, by weight: Na (10,562); Mg (1,272); Ca (400). When a current is passed though seawater these ions collect at the cathode creating a high pH and a solution dominated by sodium hydroxide. Under these conditions the magnesium precipitates as the hydroxide and the calcium as a carbonate since there is enough CO₂ in seawater in dissolved form and as the carbonate ion. Artificial reefs have been formed this way using steel mesh cathodes (see Hilbertz W (1992) Solar-generated building material from seawater as a sink for carbon Ambio 21(2) 126-129.). The NaOH and Na₂CO₃ cathodic solution is expected to be used to precipitate large quantities of Ca and Mg from seawater pumped in for this purpose. When seawater is raised in pH precipitation occurs including Ca and Mg and 0.15 mols/liter of added NaOH will complete the precipitation (see Kapp, E. M. (1928) Science, Vol. 67. 513.). Thus if the cathodic solution is mixed with a proper amount of seawater several times as much Ca and Mg carbonate will be precipitated compared to the Ca and Mg precipitated at the cathode.

If the carbonates and effluent fluid from many turbines are transported to a central place for deposit there will form a very large rapidly sinking current which will descend far without confinement, driven by the dense Ca and Mg carbonate cakes. It will be an artificial vortex or maelstrom. If large enough it will go very deep with limited mixing with seawater, depositing the Ca and Mg carbonates on the sea bottom.

### Summary of the Ocean Carbon Cycle

The units used are gigatons (Gt) of C as CO₂ and Gt per year for rates. Organic C is ignored. Estimates vary between different published sources but the differences are unimportant for the purposes here. The oceans contain 37,000 Gt C mostly at great depth. Models can be made (see Haughton R A (2005) The contemporary carbon cycle. in Biogeochemistry Schlesinger W H ed. Elsevier) which include a surface region containing 700 Gt C as CO₂ which exchanges with the atmosphere at about 90 Gt/y and has a time constant measured in decades. The flow from the surface to the deep regions is perhaps 36 Gt/y suggesting a 1000 year time constant. At present as the atmospheric CO₂ continues to rise there is about a 2 GT/y excess of flow into the oceans. There is a net flow of uptake 2 Gt/y by the plants but the future of this number is uncertain. The atmospheric increase was 3.2 Gt/y net derived from 6.3 Gt/y produced from fossil fuels at the time of the data collection (2005). According to the latest IPCC report (see Climate Change (2007): Summary for policymakers of the Synthesis report of the IPCC fourth assessment report 2008) there is now about 7 Gt/yr of carbon as CO₂ released to the atmosphere. The net increase may be about 4 Gt C per year.

### Quantities of Carbon Precipitated

The electric current in electrolytic cells per unit power depends on the voltage difference between the electrodes and this can be as low as 2 volts depending on electrode material and spacing. Commercial hydrogen producing electrolysis equipment uses 62 kilowatt hours per kg of H₂, with about 2.3 volts between the electrodes. At 17 TW and 2.3 volts the total current is 7.5×10¹² amperes (/96485)=7.77×10⁷ moles/sec=2.45×10¹⁵ moles per year of sodium (principally) delivered at the cathodes. The fraction of the current leading to deposition in the form of calcium and magnesium carbonates may be more than their 11% molar composition of seawater. However taking 11% the precipitate amounts to 0.27×10¹⁵ moles of CO₂ per year equaling 3.2 gigatons Carbon per year deposited on the cathode. The cathodic seawater outflow containing sodium carbonate and NaOH is expected to be used to collect atmospheric CO₂ and then mixed with pumped seawater. The resulting 2.18×10¹⁵ moles of sodium is expected to be used to cause precipitation of the Ca and Mg in 14.5×10¹⁵ liters of seawater with appropriate mixing. If the Ca and Mg were carbonates the result comes to 11.07 Gt of C/year. Much of the NaOH is expected to be neutralized as carbonate and the volume ratio to seawater is expected to be controlled to achieve a maximum quantity of total carbonate precipitate which might approach 11.07 Gt/year of Carbon at a power level of 17 Terawatts, since both NaOH and Na₂CO₃ cause precipitation of carbonate from seawater. The result is a total of 14.27 Gt of C permanently sequestered on the sea bottom. This amounts to 0.83 Gt/yr per TW of electricity generated. To stop the increase in atmospheric CO₂ the system need achieve about 3 TW. The hydrogen is expected to replace enough carbon dioxide generation from fossil fuels to bring the total reduction in atmospheric CO₂ to 4 GT/yr and stabilize the atmospheric CO₂ level. This is expected to require significant social adjustment toward a hydrogen economy (see The Hydrogen Economy: Opportunities, Costs, Barriers, and R&D Needs, The National Academies Press, Washington, D.C., USA, 2004).

### Fate of the Precipitate

The calcium and magnesium carbonates have a slight solubility in seawater but when deposited in large volumes only the surface will be dissolved which will be a minor issue, particularly if it were dumped in a trench. There is a depth in some deep ocean regions where no calcium fossils are found due to their being dissolved in the sea water that is present at such depths and it will make some difference just what regions of the sea bottom are used for deposit. These large depths are not found near seamounts.

### Ecological Disturbance

Open ocean far from land has the fewest birds and no bats (which are frequently killed by land based wind turbines). If the structures are designed to minimize nesting opportunities the flying creature problem of ecological damage will be minimized. The bottom of the sea where the carbonates will be dumped surely has a small density of living creatures. Dumping in chosen concentrated zones will minimize the killing. The turbines are expected to form a haven for fish and heavy growth will surely occur on the submersed parts. Because of the scale of more than a hundred thousand square kilometers a new ecological situation will develop and many large and small creatures will actually benefit near the surface. If small fish live there birds will surely come and suffer risks with the blades. Of course something this new on so large a scale is unpredictable but it appears that no damage will be caused to marine ecological systems in general, though there will be changes in specific regions. The billions of tons of carbonates deposited will change many square kilometers of sea bottom around the deposit zones. When artificial reefs were made there was an increase in the growth of corals in the alkaline cathode regions and something similar could happen in the great sea bottom deposits because of increased calcium availability.

### Cost

This estimate is made for the scale just sufficient to halt the increase in atmospheric CO₂. 3 terawatts are expected to require 300000 turbines at 10 megawatts each. Allowing for downtime 500,000 turbines might be needed. The turbines at the present time cost about a million dollars each including anchorage in relatively shallow water. However mass production on this immense scale is expected to reduce the cost. Seamount anchorage is expected to be expensive. 500,000 turbines with anchoring and electrolytic units are expected to cost about 500 billion dollars. Present wind farms run about $1000 capital per KW. This estimate comes to less than that or about $166 per KW, due to savings from the very large scale.

### Alternative Embodiments

In an alternative embodiment, the system described as being sea-borne, for example on a barge or on a sea-going vessel could be provided along a seashore, using land-based facilities (e.g., land-based renewable energy sources such as wind turbines, land-based electrolytic cells, land-based droplet production and capture facilities, and land-based sequestration of the insoluble carbonates that generated (e.g., burial, for example in disused coal mines). A pipe to provide sea water for the step and for the mixing step would allow the necessary provision of seawater, and the use of a discharge pipe to return processed seawater to the sea would obviate the necessity for the facility to be sea-borne. In some embodiments, a mixed sea-borne and land-borne facility can be provided. The densities of Mg carbonate range from 1.73 gm/cc (pentahydrate) to 2.958 gm/cc (anhydrous) and those of Ca carbonate range from 2.71 gm/cc (calcite) to 2.83 gm/cc (aragonite).

### DEFINITIONS

General purpose programmable computers useful for controlling instrumentation, recording signals and analyzing signals or data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of UNIX, or of Linux. Computational results obtained in the operation of the general purpose computer can be stored for later use, and/or can be displayed to a user. At the very least, each microprocessor-based general purpose computer has registers that store the results of each computational step within the microprocessor, which results are then commonly stored in cache memory for later use.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, or publication identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A system for sequestering carbon dioxide extracted from the terrestrial atmosphere, comprising:
a renewable energy source having an output terminal, said renewable energy source configured to provide electrical power without generating carbon dioxide emissions;
an electrolytic cell configured to receive electrical energy from said output terminal of said renewable energy source, said electrolytic cell configured to electrolyze water to provide an alkaline cathodic solution;
an aeration system configured to provide an interaction of said alkaline cathodic solution with carbon dioxide present in a terrestrial atmosphere to produce a cathodic solution enriched in carbon dioxide;
a mixing system configured to mix water containing ions selected from the group consisting of calcium ions and magnesium ions with said cathodic solution enriched in carbon dioxide to produce a precipitate comprising said ions and said carbon dioxide; and
an apparatus configured to form said precipitate into a solid to be sequestered.

2. The system for sequestering carbon dioxide extracted from the terrestrial atmosphere of claim 1, wherein said renewable energy source is a wind turbine.

3. The system for sequestering carbon dioxide extracted from the terrestrial atmosphere of claim 1, wherein said electrolytic cell configured to electrolyze water is an electrolytic cell configured to electrolyze seawater.

4. The system for sequestering carbon dioxide extracted from the terrestrial atmosphere of claim 1, wherein said alkaline cathodic solution is a solution comprising NaOH.

5. The system for sequestering carbon dioxide extracted from the terrestrial atmosphere of claim 1, wherein said cathodic solution enriched in carbon dioxide comprises Na₂CO₃.

6. The system for sequestering carbon dioxide extracted from the terrestrial atmosphere of claim 1, wherein said system is configured to be seagoing.

7. The system for sequestering carbon dioxide extracted from the terrestrial atmosphere of claim 1, wherein said solid to be sequestered is configured to be sequestered by being deposited in an ocean.

8. A method of sequestration of carbon dioxide extracted from the terrestrial atmosphere, comprising the steps of:
electrolyzing an aqueous solution using a renewable source of electrical power that operates without generating carbon dioxide to provide an alkaline cathodic solution;
reacting said alkaline cathodic solution with carbon dioxide present in a terrestrial atmosphere to produce a cathodic solution enriched in carbon dioxide;
mixing water containing ions selected from the group consisting of calcium ions and magnesium ions with said cathodic solution enriched in carbon dioxide to produce a precipitate comprising said ions and said carbon dioxide;
separating said precipitate as a solid from said mixture of water and said cathodic solution; and
sequestering said solid.

9. The method of sequestration of carbon dioxide extracted from the terrestrial atmosphere of claim 8, wherein said aqueous solution that is electrolyzed is seawater.

10. The method of sequestration of carbon dioxide extracted from the terrestrial atmosphere of claim 8, wherein said alkaline cathodic solution comprises NaOH.

11. The method of sequestration of carbon dioxide extracted from the terrestrial atmosphere of claim 8, wherein said a renewable source of electrical power that operates without generating carbon dioxide is a wind turbine.

12. The method of sequestration of carbon dioxide extracted from the terrestrial atmosphere of claim 8, wherein said cathodic solution enriched in carbon dioxide comprises Na₂CO₃.

13. The method of sequestration of carbon dioxide extracted from the terrestrial atmosphere of claim 8, wherein said step of separating said precipitate as a solid comprises subjecting said precipitate to centrifugation.

14. The method of sequestration of carbon dioxide extracted from the terrestrial atmosphere of claim 8, wherein said step of sequestering said solid comprises depositing said solid in an ocean.

15. The method of sequestration of carbon dioxide extracted from the terrestrial atmosphere of claim 8, wherein said electrolysis step provides H₂ as a product.

16. The method of sequestration of carbon dioxide extracted from the terrestrial atmosphere of claim 8, wherein said electrolysis step provides Cl₂ as a product.
